(19) United States
(12) Patent Application Publication
(10) Pub. No.: US 2025/0215233 A1
(43) Pub. Date: Jul. 3, 2025

(54) PRODUCT FOR INCREASED VISCOSITY

(71) Applicant: Active Minerals International, LLC, Sparks, MD (US)

(72) Inventors: Bo WANG, Houston, TX (US); Nestor Alirio CRUZ, Houston, TX (US); Dennis PARKER, Victor, ID (US)

(73) Assignee: Active Minerals International, LLC, Sparks, MD (US)

(21) Appl. No.: 18/400,034

(22) Filed: Dec. 29, 2023

(51) Int. Cl. C09C 1/42; C09C 3/04; C09D 7/20; C09D 7/40; C09D 7/43; C09D 7/61; C09D 167/06

(52) U.S. Cl. CPC C09C 1/42; C09C 3/041; C09D 7/20; C09D 7/43; C09D 7/61; C09D 7/68; C09D 7/69; C09D 167/06; C01P 2004/61; C01P 2004/62; C01P 2006/11; C01P 2006/12; C01P 2006/22; C01P 2006/90

(57) ABSTRACT

The product disclosed herein may comprise a jet milled clay, wherein the jet milled clay includes (a) jet milled attapulgite or (b) jet milled sepiolite or (c) jet milled attapulgite and jet milled sepiolite. The product or the jet milled clay may have a bulk density of 140-400 kg/m3. The product or the jet milled clay may have a particle size distribution having a d95 of 8-13 microns. The product or the jet milled clay may have a Zeta potential in a range of −3.5 to −9 mV or −3 to −7 mV as measured in distilled water. The product or the jet milled clay may have a surface area in the range of 110-190 m2/g as measured using the BET method. Also disclosed is a method of making such product, and a nonpolar liquid comprising a nonpolar solvent and the product.

### TECHNICAL FIELD

The present disclosure generally relates to products comprising clay that are used in nonpolar liquids such as solvent-based paints or coatings and alkyd paints.

### BACKGROUND

Paints and coatings are complex composites and as such can become unstable and may develop inconsistent uniformity of application over time from syneresis, shear thinning, or film build. Changes in spreadability may be exhibited as well as feathering behavior, spattering and/or sag of applied applications. Changes in tint strength and hide may also result. Inorganic minerals such as clays may be added to such paints and coatings to help provide a more stable shelf-life, facilitate application ease to substrates, and help provide lasting durability in varied environments.

U.S. Pat. No. 9,522,981 (the '981 Patent) describes use of thickeners in modifying the rheology of non-aqueous formulations. More specifically, the '981 Patent describes the use of at least one mixed mineral organoclay rheology additive, which comprises or consists of a quaternary alkyl-ammonium salt treated mineral clay mixture prepared by forming an aqueous hormite clay slurry (a), forming an aqueous smectite clay slurry (b), combining the aqueous hormite clay slurry (a) with the aqueous smectite clay slurry (b) to form a combined clay slurry (c), treating the combined clay slurry (c) with one or more quaternary alkyl-ammonium salts. A better and more cost effective additive is desired for use with nonpolar liquids.

### SUMMARY OF THE DISCLOSURE

In one aspect of the present disclosure, a product is disclosed. The product may comprise a jet milled clay, wherein the jet milled clay includes (a) jet milled attapulgite or (b) jet milled sepiolite or (c) jet milled attapulgite and jet milled sepiolite. The product or the jet milled clay may have a bulk density of 140-400 kg/m³. The product or the jet milled clay may have a particle size distribution having a d95 of 8-13 microns. The product or the jet milled clay may have a Zeta potential in a range of −3.5 to −9 mV or −3 to −7 mV as measured in distilled water. The product or the jet milled clay may have a surface area in the range of 110-190 m²/g as measured using the BET method.

In another aspect of the disclosure, a method of producing a product for increasing viscosity in a nonpolar liquid that comprises a nonpolar solvent is disclosed. The product may comprise a jet milled clay. The method may comprise selecting a clay as feed material, wherein the clay may comprise (a) attapulgite or (b) sepiolite or (c) attapulgite and sepiolite, and jet milling the clay to produce the jet milled clay. Wherein the product or the jet milled clay may have a bulk density of 140-400 kg/m³, and a particle size distribution having a d95 of 8-13 microns, a Zeta potential of −3.5 to −9 mV as measured in distilled water, and a surface area in the range of 110-190 m²/g as measured using the BET method, and is adapted to provide a zero to less than 15% syneresis over a twenty-four hour time period when mixed with the nonpolar liquid.

In yet another aspect of the disclosure, a nonpolar liquid is disclosed. The nonpolar liquid may comprise: a nonpolar solvent; and a product that includes a jet milled clay. The jet milled clay may include (a) a jet milled attapulgite or (b) a jet milled sepiolite or (c) the jet milled attapulgite and the jet milled sepiolite, wherein the product or the jet milled clay has a bulk density of 140-400 kg/m³ or 160-260 kg/m³, a particle size distribution having a d95 of 8-13 microns, a Zeta potential in a range of −3.5 to −9 mV as measured in distilled water, and a surface area in the range of 110-190 m²/g as measured using the BET method, wherein the product is loaded in the nonpolar liquid at a weight percentage to give the nonpolar liquid a viscosity of 34 (mPa·s) to 500 (mPa·s) at shear rate of 290 s⁻¹.

### BRIEF DESCRIPTION OF THE DRAWINGS

FIG. 1 is a graph illustrating the particle size (in microns (μm)) and differential volume (%) distribution of Example 14.

FIG. 2 is a scanning electron microscope (SEM) image of Example 14 at low magnification (×1500).

FIG. 3 is a SEM image of Feed Material A (natural attapulgite) at ×2500 magnification.

FIG. 4 is a SEM image of Feed Material A (natural attapulgite) at ×25,000 magnification.

FIG. 5 is a SEM image of Example 14 at high magnification (×25,000).

FIG. 6 is a graph illustrating the relationship between the d₉₅ (microns) and viscosity in millipascal-second (mPa·s) at a shear rate of 290 reciprocal seconds (s⁻¹) for Examples 8-14, and commercially available Min-U-Gel® 400 and Attagel® 50 products in mineral spirits.

FIG. 7 is a graph illustrating the relationship between the d₉₅ (microns) and viscosity (mPa·s) at a shear rate of 290 s⁻¹ for Examples 1-7, and commercially available Min-U-Gel 400 and Attagel 50 products in mineral spirits.

FIG. 8 is a rheogram illustrating the relationship between shear stress measured in pascals (Pa) at different shear rates (s⁻¹) in mineral spirits for Examples 1-2 and 5-6, and commercially available Min-U-Gel 400 and Attagel 50 products.

FIG. 9 is a rheogram illustrating the relationship between shear stress (Pa) at different shear rates (s⁻¹) in mineral spirits for Examples 8, 10, 12 and 14, and commercially available Min-U-Gel 400 and Attagel 50 products.

FIG. 10 is a graph illustrating the relationship between the Zeta potential measured in millivolts (mV) and the viscosity in mPa·s at a shear rate of 290 s⁻¹ in mineral spirits.

FIG. 11 is a graph illustrating the relationship between viscosity (in mPa·s at a shear rate of 290 s⁻¹) and bulk density (kilograms per meter cubed (kg/m³)) of the samples.

FIG. 12 is a graph illustrating in-situ real time viscosity at 290 s⁻¹ centipoise (cP) and dispersion mixing time of example 9, as compared to commercially available Min-U-Gel 400 and Attagel 50 products.

FIG. 13 is a graph illustrating the syneresis percent (%) over time (hours) in mineral spirits as measured for air classified examples 1, 5 and 6 of the present disclosure and commercially available Min-U-Gel 400 and Attagel 50 products.

FIG. 14 is a photo of the syneresis seen after 1 hour for the Min-U-Gel 400 and Attagel 50 products and for the air classified samples examples 1, 5 and 6.

FIG. 15 is a photo of the syneresis seen after 24 hours for the Min-U-Gel 400 and Attagel 50 products and for the air classified samples examples 1, 5 and 6.

FIG. 16 is a graph illustrating the syneresis percent (%) over time (hours) in mineral spirits as measured for jet milled examples 8, 9 and 13 of the present disclosure and commercially available Min-U-Gel 400 and Attagel 50 products.

FIG. 17 is a photo of the syneresis seen after 1 hour for the Min-U-Gel 400 and Attagel 50 products and for the jet milled examples 8, 9 and 13 of the present disclosure.

FIG. 18 is a photo of the syneresis seen after 24 hours for the Min-U-Gel 400 and Attagel 50 products and for the jet milled examples 8, 9 and 13 of the present disclosure.

### DETAILED DESCRIPTION

This disclosure relates to a product for improving the viscosity in a nonpolar liquid that comprises a nonpolar solvent. Such nonpolar liquid may include, but is not limited to, a solvent-based coating. The solvent-based coating may include, but is not limited to, varnish, lacquer, paint, ink, alkyd paint, or the like, each may be referred to herein as a “solvent-based coating”. The novel products disclosed herein may comprise jet milled clay, wherein the jet milled clay may comprise, or may be, (a) jet milled attapulgite, or (b) jet milled sepiolite, or (c) jet milled attapulgite and jet milled sepiolite. The products disclosed herein may be jet milled attapulgite, jet milled sepiolite or mixtures thereof. Attapulgite is sometimes referred to as palygorskite. To avoid confusion, as used herein, the term “attapulgite” means attapulgite and/or palygorskite. As is known in the art, attapulgite is a chain crystal lattice type of clay mineral that is structurally different from other clays such as montmorillonite or bentonite. Namely, the tetrahedral sheets of attapulgite are divided into ribbons by inversion because adjacent bands of tetrahedra within one tetrahedral sheet point in opposite directions rather than in one direction thus creating a structure of ribbons of 2:1 layers joined at their edges, and the octahedral sheets are continuous in two dimensions only. Sepiolite is a hydrated magnesium silicate. The structures of both attapulgite and sepiolite are similar in that tetrahedra pointing in the same direction form 2:1 ribbons that extend in the direction of the a-axis and have an average b-axis width of three linked tetrahedral chains in sepiolite and two linked chains in attapulgite. Attapulgite and sepiolite are structurally different than other clays and do not swell with addition of either water or organic solvents. In one embodiment, the product may be substantially free of bentonite, kaolinite or talc. In an embodiment, the product may include 76-100 wt. % jet milled clay, wherein the jet milled clay may comprise or may be: (a) jet milled attapulgite or (b) jet milled sepiolite, or (c) jet milled attapulgite and jet milled sepiolite.

In an embodiment, the product may have a bulk density of 140-400 kg/m³ or 160-260 kg/m³ or 150-260 kg/m³ or 140-385 kg/m³ or 140-370 kg/m³ or 140-355 kg/m³ or 140-320 kg/m³ or 140-275 kg/m³ or 140-210 kg/m³ or 140-195 kg/m³.

In any one of the embodiments above, such product or jet milled clay may have a surface area in the range of 110-190 m²/g or 110-140 m²/g as measured using the Brunauer-Emmett-Teller (BET) theory.

In any one of the embodiments above, such product or jet milled clay may have a particle size distribution having a d₉₅ of: 8-13 microns, or 7-13 microns or 7-12 microns or 7-11 microns or 7-10 microns or 7-9 microns or 7-8 microns.

In any one of the embodiments above, such product or jet milled clay may have a particle size distribution having a d₉₀ of: 8-11 microns, or 7-11 microns or 7-10 microns or 7-9 microns or 7-8 microns.

In any one of the embodiments above, such product or jet milled clay may have a particle size distribution having a d₅₀ of 0.5-4 microns or 3-4 microns or 0.5-3 microns or 0.5-2 microns or 0.5-1 micron.

In any one of the embodiments above, such product or jet milled clay may have a particle size distribution having a d₁₀ of 0.1-0.7 microns or 0.2-0.7 microns or 0.1-0.6 microns or 0.1-0.5 microns or 0.1-0.4 microns or 0.1-0.3 microns or 0.1-0.2 microns.

In any one of the embodiments above, such product or jet milled clay may have a particle size distribution having a d₅ of 0.1-0.5 microns, or 0.2-0.5 microns, or 0.1-0.4 microns, or 0.1-0.3 microns or 0.1-0.2 microns.

In any one of the embodiments above, such product or jet milled clay may have a Zeta potential of −3.5 to −9 mV or −3.5 to −8 mV or −3 to −7 mV or −3.5 to −6 mV or −3.5 to −5 mV, each as measured in distilled water.

In any one of the embodiments above, such product may be adapted to increase a viscosity of a nonpolar liquid to a range of 34 (mPa·s) to 500 (mPa·s) at shear rate of 290 s⁻¹ as measured in the nonpolar liquid (after dispersal of a 20 wt. % solid loading of the product in the nonpolar liquid) and as compared to the (initial) viscosity of the nonpolar liquid when free of the product, wherein the nonpolar liquid comprises a nonpolar solvent. In any one of the embodiments above, such product may be adapted to increase a viscosity of the nonpolar liquid to a range of 80 (mPa·s) to 450 (mPa·s) at shear rate of 290 s⁻¹ as measured in the nonpolar liquid (after dispersal of a 20 wt. % solid loading of the product in the nonpolar liquid) and as compared to the (initial) viscosity of the nonpolar liquid when free of the product, wherein the nonpolar liquid comprises a nonpolar solvent. In any one of the embodiments above, such product may be adapted to increase a viscosity of a nonpolar liquid to a range of 33 (mPa·s) to 410 (mPa·s) at shear rate of 290 s⁻¹ as measured in the nonpolar liquid (after dispersal of a 20 wt. % solid loading of the product in the nonpolar liquid) and as compared to the (initial) viscosity of the nonpolar liquid when free of the product, wherein the nonpolar liquid comprises a nonpolar solvent. In any one of the embodiments above, such product may be adapted to increase a viscosity of a nonpolar liquid to a range of 33 (mPa·s) to 330 (mPa·s) at shear rate of 290 s⁻¹ as measured in the nonpolar liquid (after dispersal of a 20 wt. % solid loading of the product in the nonpolar liquid) and as compared to the (initial) viscosity of the nonpolar liquid when free of the product, wherein the nonpolar liquid comprises a nonpolar solvent. In any one of the embodiments above, such product may be adapted to increase a viscosity of a nonpolar liquid to a range of 33 (mPa·s) to 240 (mPa·s) at shear rate of 290 s⁻¹ as measured in the liquid (after dispersal of a 20 wt. % solid loading of the product in the nonpolar liquid) and as compared to the (initial) viscosity of the nonpolar liquid when free of the product, wherein the nonpolar liquid comprises a nonpolar solvent. In any one of the embodiments above, such product may be adapted to increase a viscosity of a nonpolar liquid to a range of 33 (mPa·s) to 500 (mPa·s) at shear rate of 290 s⁻¹ as measured in the nonpolar liquid (after dispersal of a 20 wt. % solid loading of the product in the nonpolar liquid) and as compared to the (initial) viscosity of the nonpolar liquid when free of the product, wherein the nonpolar liquid comprises a nonpolar solvent. In any one of the embodiments above, such product may be adapted to increase a viscosity of a nonpolar liquid to a range of 33 (mPa·s) to 80 (mPa·s) at shear rate of 290 s⁻¹ as measured in the nonpolar liquid (after dispersal of a 20 wt. % solid loading of the product in the nonpolar liquid) and as compared to the (initial) viscosity of the nonpolar liquid when free of the product, wherein the nonpolar liquid comprises a nonpolar solvent. In any one of the embodiments above, such product may be adapted to increase a viscosity of a nonpolar liquid to a range of 33 (mPa·s) to 70 (mPa·s) at shear rate of 290 s⁻¹ as measured in the nonpolar liquid (after dispersal of a 20 wt. % solid loading of the product in the nonpolar liquid) and as compared to the (initial) viscosity of the nonpolar liquid when free of the product, wherein the nonpolar liquid comprises a nonpolar solvent. In any one of the embodiments above, such product may be adapted to increase a viscosity of a nonpolar liquid to a range of 33 (mPa·s) to 60 (mPa·s) at shear rate of 290 s⁻¹ as measured in the nonpolar liquid (after dispersal of a 20 wt. % solid loading of the product in the nonpolar liquid) and as compared to the (initial) viscosity of the nonpolar liquid when free of the product, wherein the nonpolar liquid comprises a nonpolar solvent. In any one of the embodiments above, such product may be adapted to increase a viscosity of a nonpolar liquid to a range of 33 (mPa·s) to 50 (mPa·s) at shear rate of 290 s⁻¹ as measured in the nonpolar liquid (after dispersal of a 20 wt. % solid loading of the product in the nonpolar liquid) and as compared to the (initial) viscosity of the nonpolar liquid when free of the product, wherein the nonpolar liquid comprises a nonpolar solvent. In any one of the embodiments above, such product may be adapted to increase a viscosity of a nonpolar liquid to a range of 33 (mPa·s) to 40 (mPa·s) at shear rate of 290 s⁻¹ as measured in the nonpolar liquid (after dispersal of a 20 wt. % solid loading of the product in the nonpolar liquid) and as compared to the (initial) viscosity of the nonpolar liquid when free of the product, wherein the nonpolar liquid comprises a nonpolar solvent. Such nonpolar solvent may include but is not limited to, Hexane, mineral spirits, aromatics (Benzene, Toluene, Xylene), Pentane, Cyclohexane, ethyl acetate cyclohexanone, Diethyl ether, Chloroform, 1,4-Dioxane, or the like.

In any one or more of the embodiments above, the attapulgite or sepiolite used in the feed material for the product may be or may comprise: (a) natural attapulgite or natural sepiolite that may be free of heat treatment (at 300° C. to about 800° C.), and/or free of calcination (e.g., at about 800° C. or above). In any one or more of the embodiments above, the attapulgite or sepiolite may be in powder form. In any one or more of the embodiments above, the attapulgite or sepiolite may be free of spray drying.

In any one or more of the embodiments above, the product may be adapted to provide zero to less than 15% syneresis or zero to less than 10% syneresis or zero to less than 5% syneresis over a twenty-four hour time period to the nonpolar liquid containing the product, wherein the nonpolar liquid comprises a nonpolar solvent.

Also disclosed is a method of producing a product for increasing viscosity in a nonpolar liquid that comprises a nonpolar solvent, the product comprising a jet milled clay. The method may comprise: selecting a clay as feed material, wherein the clay may comprise or may be (a) attapulgite or (b) sepiolite or (c) attapulgite and sepiolite; jet milling the clay to produce the jet milled clay, wherein the product or the jet milled clay may have a bulk density of 140-400 kg/m³, a particle size distribution having a d₉₅ of 8-13 microns, a Zeta potential of −3.5 to −9 mV as measured in distilled water, and a surface area in the range of 110-190 m²/g as measured using the BET method, and may be adapted to provide less than 15% syneresis over a twenty-four hour time period when mixed with the nonpolar liquid. In an embodiment, a weight percentage of components of the product may include 76-100 wt. % jet milled clay. In any one or more of the embodiments above, the jet milled clay or the product may have a bulk density of 160-260 kg/m³. In any one or more of the embodiments above, the jet milled clay or the product may have a particle size distribution having a d₅₀ of 3-4 microns. In any one or more of the embodiments above, the jet milled clay or the product may have a particle size distribution having a d₅ of 0.2-0.5 microns. In any one or more of the embodiments above, the jet milled clay or the product may have a Zeta potential of −3 to −7 mV as measured in distilled water. In any one or more of the embodiments above, the product at 20 wt. % solid loading in the nonpolar liquid may be adapted to increase a viscosity of the nonpolar liquid to a range of 34 (mPa·s) to 500 (mPa·s) at shear rate of 290 s⁻¹ as measured after dispersal of the product in the nonpolar liquid and as compared to the nonpolar liquid when free of the product. In any one or more of the embodiments above, the product may be adapted to provide zero to less than 15% syneresis, or zero to less than 10% syneresis, or zero to less than 5% syneresis over a twenty-four hour time period to the nonpolar liquid containing the product.

Also disclosed is a nonpolar liquid comprising: a nonpolar solvent; and a product that includes a jet milled clay. The jet milled clay may include or may be (a) a jet milled attapulgite or (b) a jet milled sepiolite or (c) jet milled attapulgite and jet milled sepiolite, wherein the product or the jet milled clay may have a bulk density of 140-400 kg/m³ or 160-260 kg/m³, a particle size distribution having a d₉₅ of 8-13 microns, a Zeta potential in a range of −3.5 to −9 mV as measured in distilled water, and a surface area in the range of 110-190 m²/g as measured using the BET method, wherein the product is loaded in the nonpolar liquid at a weight percentage (e.g., 20 wt. % solid loading) to give the nonpolar liquid a viscosity of 34 (mPa·s) to 500 (mPa·s) at shear rate of 290 s⁻¹. In an embodiment, the product may be loaded in the nonpolar liquid at a weight percentage to give the nonpolar liquid a viscosity of 80 (mPa·s) to 500 (mPa·s) at shear rate of 290 s⁻¹. In an embodiment, the nonpolar liquid may be a solvent-based coating (e.g., varnishes, lacquers, paints, inks, alkyd paints). In an embodiment, the nonpolar liquid may be an adhesive or a sealant. In an embodiment, the nonpolar liquid may have 0% to 15%, or 0% to 10%, or 0% to 5% syneresis within twenty-four hours after mixing of the nonpolar solvent and the product of the nonpolar liquid. In an embodiment, the jet milled clay may be 76-100 wt. % of the product.

### Description of Test Methods

### Particle Size Analysis

Particle size distribution was measured using Mastersizer 3000 laser particle analyzer equipped with a hydro MV dispersion unit (Malvern Panalytical Inc., MA). The representative samples of each material were fully dispersed before particle size distribution analysis using the following procedure. 300 milliliters (mL) of water was poured into the Ninja single-serve cup of a Ninja Nutri Blender Pro. Next three grams of the sample was added to the Ninja single-serve cup along with 0.06 grams (g) of hexametaphosphate dispersant. The mixture was then blended in the Ninja Nutri Blender Pro for a total of two minutes. After mixing, the sample was transferred to a 500 mL beaker with a magnetic stir bar inside and set on a magnetic stirrer with a low mixing speed. The settings used for the particle size distribution measurement consisted of a refractive index of 1.52, an absorption index of 0.01, and attapulgite density 2.3 grams per cubic centimeter (g/cm³), with six-minute sonication at 2,500 revolutions per minute (rpm), and a two-minute pre-measurement delay. Once the instrument was ready to load the sample, a clean pipette was used to pick up the created slurry and add enough into the hydro MV dispersion unit tank until the obscuration was green. A total of five measurements were taken for each sample and an average particle size distribution generated.

### Surface Area, Pore Volume, Pore Size Distribution

Surface area was measured by the nitrogen adsorption method of the BET (Brunauer-Emmett-Teller) method. Pore volume and pore size distribution of a sample of material was determined by mercury porosimetry. The mercury porosimetry uses mercury as an intrusion fluid to measure pore volume of a (weighed) sample of material enclosed inside a sample chamber of a penetrometer. The sample chamber is evacuated to remove air from the pores of the sample. The sample chamber and penetrometer are filled with mercury. Since mercury does not wet the material surface, it must be forced into the pores by means of external pressure. Progressively higher pressure is applied to allow mercury to enter the pores. The required equilibrated pressure is inversely proportional to the size of the pores, only slight pressure is required to intrude the mercury into macropores, whereas much greater external pressure is required to force mercury into small pores. The penetrometer reads the volume of mercury intruded and the intrusion data is used to calculate pore size distribution, porosity, average pore size and total pore volume. A Micromeritics AutoPore IV 9500 was used to analyze the samples herein.

Assuming pores of cylindrical shape, a surface distribution may be derived from the pore volume distribution for use in calculations. An estimate of the total surface area of the sample of material may be made from the pressure/volume curve (Rootare, 1967) without using a pore model as

$$A = \frac{1}{γ cos θ} {\int }_{{y}_{Hq , 0}}^{{y}_{Hg , max}} pdV$$

Where, A=total surface area
γ=surface tension of the mercury
θ=angle of contact of mercury with the material pore wall
p=external applied pressure
V=pore volume
   From the function V=V(p) the integral may be calculated by means of a numerical method.

From the pressure versus the mercury intrusion data, the instrument generates volume and size distribution of pores following the Washburn equation (Washburn, 1921) as:

$${d}_{i} = \frac{4 γ cos θ}{{P}_{i}}$$

Where, dᵢ=diameter of pore at an equilibrated external pressure
γ=surface tension of the mercury
θ=angle of contact of mercury with the material pore wall
Pᵢ=external applied pressure

The average pore diameter is determined from cumulative intrusion volume and total surface area of the sample of material as:

$$D = \frac{4 V}{S}$$

Where, D=average pore diameter
V=total intrusion volume of mercury
S=total surface area

### Shear Rate

Shear represents relative motion between adjacent layers of a moving liquid. Shear rate is the measure of the extent or rate of relative motion between adjacent layers of a moving liquid. Shear Rate may be calculated by the following formula:

$$Shear Rate = Velocity / Distance$$

### Test Method—for Viscosity in Solvent at Different Shear Rates

Viscosity in a selected solvent at a selected shear rate may be measured and used to compare different materials. According to the test method, a 20 wt. % solids dispersion of a representative sample of the test material in 80 wt. % mineral spirits is prepared in a 100 milliliter (ml) beaker, and mixed for 30 minutes with a magnetic stirrer at 1000 rpm using a 3.81 cm (1.5 inch) magnetic bar. After mixing the suspension for 30 minutes, a 45 ml sample is taken to measure rheology using a rheometer such as a Brookfield R/S+ rheometer along with a bob and cup geometry (CCT-40 cylinder) to produce a rheogram. Three steps are used: pre-shear for 10 seconds at 1000 s⁻¹, a five second resting period with no shear, and logarithmic ascending (0.3 s⁻¹ to 1000 s⁻¹) and descending (1000 s⁻¹ to 0.3 s⁻¹) ramps for a total of 120 points measured in 240 seconds. The resulting rheograms show the difference between tested samples, at specific shear rates that may be selected (e.g., 290 s⁻¹ and 1000 s⁻¹) to compare apparent viscosities of the suspensions. The viscosity measurements in mineral spirits associated with each sample is reported in millipascal-second (mPa·s) at the selected shear rate (e.g., 290 s⁻¹).

### Loss on Ignition (LOI)

Loss on Ignition (LOI) may be used to determine the water of hydration in a sample of feed material. Such a LOI test should be carried out at high temperature (for example 980° C.-1200° C., preferably, 982° C.-1000° C.) for a sufficient time (at least 1 hour) so that chemically-bound water has a chance to disassociate and volatilize. Precise measurement of sample mass (to the nearest 0.1 mg) before and after this treatment allows quantification of the water of hydration.

### Preparation of the Products

The method of producing the products discussed above may comprise selecting a clay for processing. The clay may comprise or may be (a) natural attapulgite or (b) natural sepiolite or (c) natural attapulgite and natural sepiolite. Attapulgite/palygorskite is a magnesium aluminium phyllosilicate with the chemical formula (Mg,Al)₂Si₄O₁₀(OH)·₄H₂O. Sepiolite is a fibrous hydrated magnesium silicate with the chemical formula Mg₄Si₆O₁₅(OH)₂·6H₂O. The percentages of the various elements may vary depending on the deposit from which the attapulgite or sepiolite is sourced. Both minerals have similar crystal structure with three linked tetrahedral chains in sepiolite and two linked chains in attapulgite.

In any one or more of the embodiments above, the clay feed material may be or may comprise natural attapulgite or natural sepiolite that prior to processing may be free of heat treatment (at 300° C. to about 800° C.) and free of calcination (e.g., at about 800° C. or above). In any one or more of the embodiments above, the clay feed material may be free of spray drying.

The natural attapulgite or natural sepiolite selected may have a high surface area in the range of 90 m²/g-180 m²/g, as measured by the nitrogen adsorption method based on the Brunauer-Emmett-Teller (BET) theory, and a particle size (d50) (as measured by a laser particle size analyzer) of 3-25 microns. In any one or more of the embodiments, the natural attapulgite or natural sepiolite selected as feed material may have a particle size distribution of d95 (as measured by a laser particle size analyzer) of 20-90 microns or 20-80 microns. In a refinement, the natural attapulgite or natural sepiolite may have surface area in the range of 100 m²/g-140 m²/g, as measured by the nitrogen adsorption method based on the Brunauer-Emmett-Teller (BET) theory. In a further refinement, the particle size (d50) of the feed material, as measured by a laser particle size analyzer, may be 6-18 microns, 6-14 microns or 7-13 microns. In each of the embodiments and refinements above, the natural attapulgite or natural sepiolite (feed material) may include about 7-about 16 wt. % or about 9-about 14 wt. % moisture (measured after heating the material to 104° C. (220° F.)). FIG. 4 is a SEM image of feed material comprising natural attapulgite at ×25000 magnification. As can be seen in FIG. 4, the feed material may comprise attapulgite, which may comprise a plurality of rod shaped attapulgite particles.

The method of producing the novel products herein further comprises jet milling the clay to produce jet milled clay.

### EXAMPLES

The products of Examples 1-14 each comprise attapulgite. The products of Examples 1-14 were prepared from the different attapulgite feed materials listed in Table 1.

TABLE 1
Feed Materials.

| | | Surface | | | | | |
|---|---|---|---|---|---|---|---|
| | Feed | Area | d5 | d10 | d50 | d90 | d95 |
| | material | (m²/g) | (μm) | (μm) | (μm) | (μm) | (μm) |
| Feed | Natural | 105 | 0.259 | 0.358 | 7.63 | 30.3 | 41.7 |
| Material A | attapulgite | | | | | | |
| Feed | Min-U- | 138 | 0.289 | 0.413 | 11.8 | 53.9 | 78.6 |
| Material B | Gel 200 ® | | | | | | |

The natural attapulgite feed material of Feed Material A was prepared using natural attapulgite mined near Climax, Georgia by Active Minerals International, LLC. The major elemental composition of this natural attapulgite feed material, as determined by wave-length dispersive XRF analysis, is shown in Table 2.

TABLE 2
Major Oxide Composition of natural attapulgite
material used as feed material (Ignited Basis).
Total Chemistry as determined by XRF (expressed as oxides)¹

| | |
|---|---|
| SiO₂ (wt. %) | 66.2 |
| Al₂O₃ (wt. %) | 12.1 |
| Fe₂O₃ (wt. %) | 4.2 |
| CaO (wt. %) | 2.8 |
| MgO (wt. %) | 9.9 |
| K₂O (wt. %) | 1.1 |
| CO₂ (wt. %) | 1.8 |
| TiO₂ (wt. %) | 0.6 |
| P₂O₅ (wt. %) | 1.0 |
| SO₄ (wt. %) | 0.2 |
| Other | 0.1 |

¹Although the elements are reported as oxides, they are actually present as complex aluminosilicates.

The Feed Material A comprising natural attapulgite had a surface area of about 105 m²/g, as measured by the nitrogen adsorption method based on the Brunauer-Emmett-Teller (BET) theory. Particle size (d₅₀) of this feed material, as measured by a laser particle size analyzer, was around 7.63 microns (μm). Particle size (d₉₅) of this feed material, as measured by a laser particle size analyzer, was around 41.7 microns. The natural attapulgite feed material was in powder form and was free of extrusion. The natural attapulgite feed material was free of heat treatment (at 300° C. to about 800° C.), and/or free of calcination (e.g., at about 800° C. or above). The natural attapulgite feed material A contains about 12 wt. % moisture (measured after heating the sample to 104° C. (220° F.)) and was free of spray drying.

Feed Material B was prepared using the commercially available Min-U-Gel® 200 (Active Minerals International, LLC) as feed material. The Min-U-Gel 200 product is a non-purified natural attapulgite that has been air classified. The major elemental compositions of Min-U-Gel 200, as determined by wave-length dispersive x-ray fluorescence (XRF) analysis, is shown in Table 3. Feed material B contains about 12 wt. % moisture (measured after heating the sample to 104° C. (220° F.)) and was free of spray drying.

TABLE 3
Major Oxide Composition of air classified natural attapulgite
Min-U-Gel 200 used as feed materials (Ignited Basis).
Total Chemistry for Min-U-Gel 200 as
determined by XRF (expressed as oxides) ¹

| | |
|---|---|
| SiO₂ (wt. %) | 66.2 |
| Al₂O₃ (wt. %) | 11.7 |
| Fe₂O₃ (wt. %) | 4.0 |
| CaO (wt. %) | 2.9 |
| MgO (wt. %) | 9.7 |
| Na₂O (wt. %) | |
| K₂O (wt. %) | 1.1 |
| TiO₂ (wt. %) | 0.6 |
| P₂O₅ (wt. %) | 1.0 |
| Free Moisture, wt. % @ 220° F. (104° C.) | 12.5 |
| Residue (wet) % retained on 325 mesh screen | 6.9 |

¹ Although the elements are reported as oxides, they are actually present as complex aluminosilicates.

### Examples 1-7

Examples 1 to 7 were prepared using a pilot scale Alpine™ 200 ATP air classifier (Hosokawa Micron Powder Systems, Summit, N.J.) to classify the respective feed material. Examples of parameters for the Alpine™ 200 ATP classifier include, but are not limited to, classifier wheel speed from about 3800 revolutions per minute (rpm) to about 5000 rpm and total air flow pressure about 14,158,423 cubic centimeters per minute (cm³/min) [500 Cubic Feet per Minute (CFM)]. Table 4 identifies the respective feed material, classifier wheel speed and total air flow pressure for each of Examples 1-7.

TABLE 4
Feed Material and classifier processing
parameters for Examples 1-7.

| | | Total air | Classifier wheel |
|---|---|---|---|
| Examples | Feed material | flow (cm³/min) | speed (rpm) |
| Example 1 | Natural attapulgite | 14,158,423 | 5000 |
| Example 2 | Min-U-Gel 200 | 14,158,423 | 4500 |
| Example 3 | Min-U-Gel 200 | 14,158,423 | 3800 |
| Example 4 | Natural attapulgite | 14,158,423 | 3800 |
| Example 5 | Min-U-Gel 200 | 14,158,423 | 5000 |
| Example 6 | Natural attapulgite | 14,158,423 | 5000 |
| Example 7 | Natural attapulgite | 14,158,423 | 5000 |

### Examples 8-14

Examples 8 to 14 were prepared using a pilot scale Alpine® AFG 400 Fluidized Bed Jet Mill (Hosokawa Micron Powder Systems, Summit, N.J.) to jet mill and classify the respective feed material. Examples of parameters for the Alpine™ AFG 400 jet mill include, but are not limited to, grind air pressure about 620,527.5 Pascal (Pa) (90 pounds per square inch gauge (psig)) and classifier wheel speed from about 3500 rpm to about 4750 rpm. Table 5 identifies the respective feed material, grind air pressure and classifier wheel speed for each of Examples 8-14.

TABLE 5
Feed Material and Jet Mill Processing
Parameters for Examples 8-14.

| | | Grind air | Classifier wheel |
|---|---|---|---|
| Examples | Feed material | pressure (Pa) | speed (rpm) |
| Example 8 | Natural attapulgite | 620,527.5 | 3500 |
| Example 9 | Natural attapulgite | 620,527.5 | 2250 |
| Example 10 | Natural attapulgite | 620,527.5 | 2250 |
| Example 11 | Min-U-Gel 200 | 620,527.5 | 4000 |
| Example 12 | Min-U-Gel 200 | 620,527.5 | 4750 |
| Example 13 | Natural attapulgite | 620,527.5 | 4750 |
| Example 14 | Natural attapulgite | 620,527.5 | 4750 |

For each of feed material A (natural attapulgite), feed material B (Min-U-Gel 200), Examples 1-14, and commercially available attapulgite products Min-U-Gel 400 and Attagel 50, particle size distribution, pH, bulk density in kilograms/cubic meter (kg/m³), moisture (%) and surface area in square meters per gram (m²/g) are shown in the Table 6 below. To obtain particle size distribution in Table 6, particle size analysis was done on five representative samples of each of Examples 1-14, feed materials A-B, Min-U-Gel 400 and Attagel 50. The results of the five representative samples were averaged to determine the average or typical particle size distribution shown in Table 6 for each of Examples 1-14, feed materials A-B, Min-U-Gel 400, and Attagel 50.

TABLE 6
Particle size distribution, pH, Bulk Density, Moisture and Surface Area.

| | | | | | | | | Bulk | | Surf. |
|---|---|---|---|---|---|---|---|---|---|---|
| | | d₅ | d₁₀ | d₅₀ | d₉₀ | d₉₅ | | density | Moist | area |
| | Process | (μm) | (μm) | (μm) | (μm) | (μm) | pH | (kg/m³) | (%) | (m²/g) |
| Feed Mtl A | | 0.259 | 0.358 | 7.63 | 30.3 | 41.7 | 10.23 | 570 | 12.06 | 105 |
| (natural | | | | | | | | | | |
| attapulgite) | | | | | | | | | | |
| Feed Mtl B | | 0.289 | 0.413 | 11.80 | 53.9 | 78.6 | 9.86 | 571 | 12.00 | 138 |
| (M-U-Gel 200 | | | | | | | | | | |
| M-U-Gel 400 | | 0.175 | 0.239 | 3.58 | 13.9 | 20.1 | 9.87 | 398 | 14.95 | 174 |
| Attagel 50 | | 0.195 | 0.273 | 4.83 | 18.4 | 24.4 | 9.76 | 408 | 12.15 | 181 |
| Example 1 | Air | 0.148 | 0.200 | 2.64 | 7.97 | 9.95 | 9.83 | 383 | 13.50 | 186 |
| | classified | | | | | | | | | |
| Example 2 | Air | 0.142 | 0.187 | 1.15 | 7.25 | 9.32 | 9.74 | 361 | 14.01 | 190 |
| | classified | | | | | | | | | |
| Example 3 | Air | 0.261 | 0.347 | 2.99 | 8.96 | 11.5 | 9.79 | 349 | 12.35 | 189 |
| | classified | | | | | | | | | |
| Example 4 | Air | 0.165 | 0.216 | 2.60 | 8.16 | 9.92 | 9.85 | 375 | 12.79 | 151 |
| | classified | | | | | | | | | |
| Example 5 | Air | 0.115 | 0.149 | 0.50 | 5.15 | 7.04 | 9.65 | 341 | 12.61 | 158 |
| | classified | | | | | | | | | |
| Example 6 | Air | 0.137 | 0.184 | 1.95 | 7.45 | 9.47 | 9.74 | 352 | 13.19 | 145 |
| | classified | | | | | | | | | |
| Example 7 | Air | 0.173 | 0.237 | 3.70 | 10.2 | 12.5 | 9.84 | 395 | 13.85 | 141 |
| | classified | | | | | | | | | |
| Example 8 | Jet milled | 0.214 | 0.285 | 3.64 | 10.4 | 12.7 | 9.91 | 257 | 12.42 | 131 |
| Example 9 | Jet milled | 0.357 | 0.493 | 6.72 | 17.4 | 21.0 | 9.74 | 352 | 13.19 | 117 |
| Example 10 | Jet milled | 0.431 | 0.431 | 6.01 | 16.6 | 20.4 | 9.84 | 395 | 13.85 | 120 |
| Example 11 | Jet milled | 0.404 | 0.547 | 3.91 | 9.50 | 11.3 | 9.86 | 197 | 10.63 | 114 |
| Example 12 | Jet milled | 0.305 | 0.401 | 3.18 | 8.31 | 9.94 | 9.87 | 184 | 10.96 | 127 |
| Example 13 | Jet milled | 0.455 | 0.648 | 3.33 | 7.21 | 8.50 | 9.88 | 200 | 10.63 | 113 |
| Example 14 | Jet milled | 0.416 | 0.552 | 3.34 | 7.57 | 8.97 | 9.83 | 180 | 10.77 | 112 |

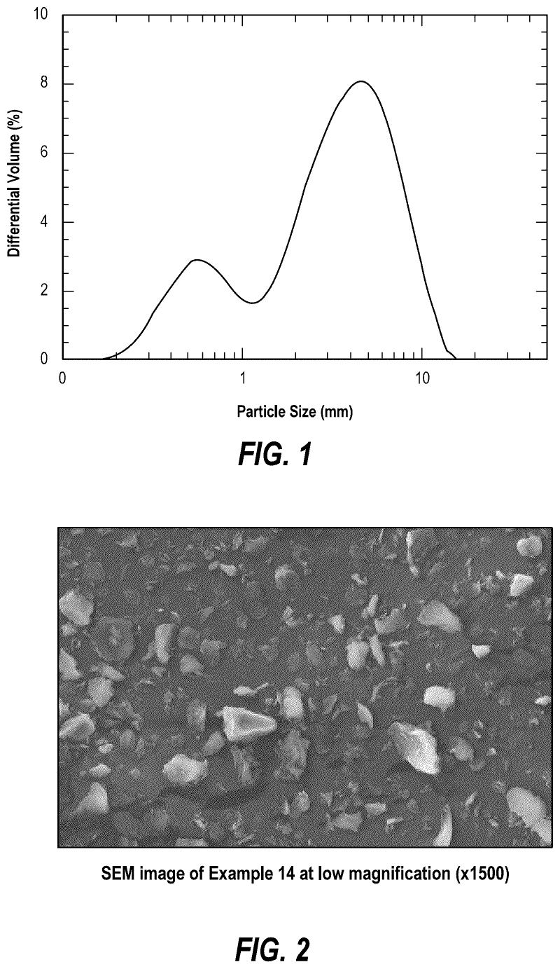

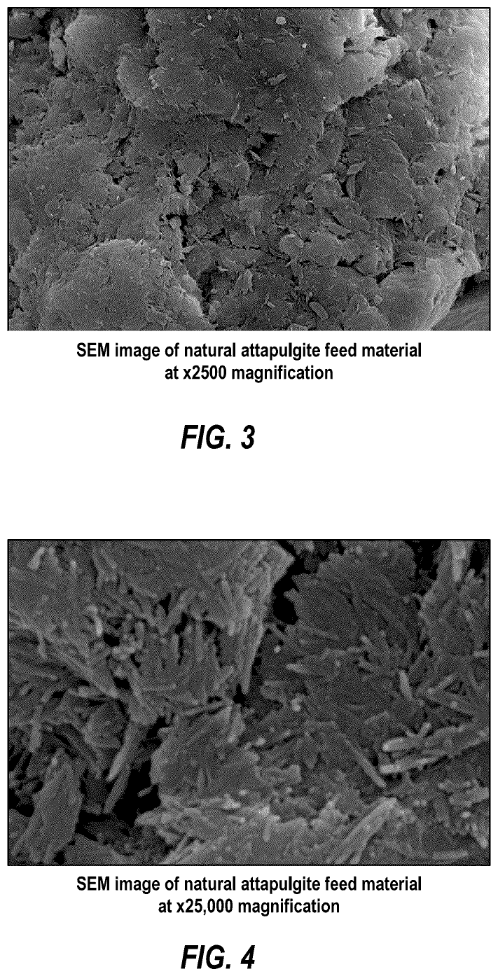

FIG. 1 illustrates the particle size distribution of Example 14 showing the bimodal distribution of Example 14. The peak at smaller microns is associated with the dispersed attapulgite rods. The peak at the larger microns is associated with the aggregated/agglomerated attapulgite rods. FIG. 2 illustrates a SEM image of Example 14 at low magnification (×1500), which shows that most of the jet milled particles of Example 14 are less than 10 microns. FIG. 3 illustrates a SEM image of the feed material A (natural attapulgite) used for Example 14, which shows the natural agglomeration of the attapulgite rods of Feed Material A. The SEM image of FIG. 3 was taken at ×2500 magnification. FIG. 4 illustrates a SEM image of feed material A (natural attapulgite) at high magnification (×25,000). FIGS. 3-4 show that the attapulgite rods of feed material A are agglomerated/bundled in the feed material.

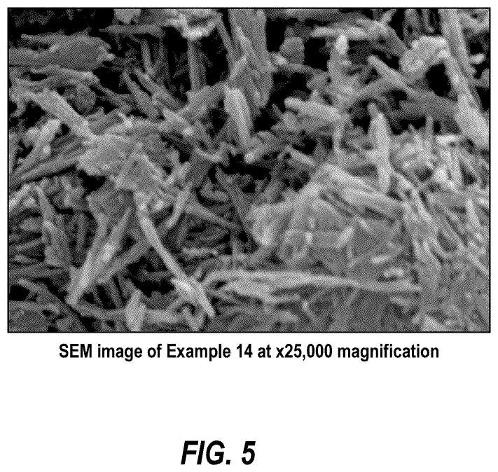

FIG. 5 is a SEM image of Example 14 at high magnification (×25,000). A comparison of the SEM images of the attapulgite feed material A (FIGS. 3-4) used for Example 14 prior to jet milling and the SEM image of the product after the jet milling processing (FIG. 5) illustrates that the jet milling process separates a substantial portion of attapulgite rods which were agglomerated together naturally.

The rhelogical behavior of each of feed material A (natural attapulgite), feed material B (Min-U-Gel 200), Examples 1-14, and commercially available attapulgite products Min-U-Gel 400 and Attagel 50, was measured in mineral spirits, an exemplary nonpolar solvent liquid. To measure the rhelogical behavior a test was used to compare each material. The test utilized was comparable to the Low-Shear Viscosity (LSV) test method defined in ASTM D7394-18 (Standard Practice for Rheological Characterization of Architectural Coatings using Three Rotational Bench Viscometers), which can be used to predict the relative “in-can” performance of coatings for their ability to suspend pigment or prevent syneresis, or both, and can also be used to predict relative performance for leveling and sag resistance after application by roll, brush or spray. For each of the materials in Table 7, a 20 wt. % solids dispersion of a representative sample of the respective attapulgite material in mineral spirits was prepared in a 100 milliliter (ml) beaker, and mixed for 30 minutes with a magnetic stirrer at 1000 rpm using a 3.81 cm (1.5 inch) magnetic bar.

The quantities of attapulgite and mineral spirits were 10 and 40 grams (g), respectively, and after mixing the suspension for 30 minutes, a 45 ml sample was taken to measure rheology. A Brookfield R/S+ rheometer was used along with a bob and cup geometry (CCT-40 cylinder) to produce a rheogram. Three steps were used: pre-shear for 10 seconds at 1000 s⁻¹, a five second resting period with no shear, and logarithmic ascending (0.3 s⁻¹ to 1000 s⁻¹) and descending (1000 s⁻¹ to 0.3 s⁻¹) ramps for a total of 120 points measured in 240 seconds. Rheograms show the difference between the samples, and specific shear rates may be selected (e.g., 290 and 1000 s⁻¹) to compare apparent viscosities of the suspensions. Table 7 shows viscosity measurements in millipascal-second (mPa·s) of the samples at shear rate of 290 s⁻¹ in mineral spirits. While the test method utilizes mineral spirits as a representative nonpolar liquid, the results of a given test material relative to the other tested materials are indicative of the relative performance of the various materials (as compared to each other) in other nonpolar solvent based liquids such as coatings or the like, and so is very helpful to identify materials processed to provide superior rheological properties.

TABLE 7
Viscosity (mPa · s) at shear rate of 290 s⁻¹ in mineral spirits.

| | Viscosity (mPa · s) at |
|---|---|
| Samples | shear rate of 290 s⁻¹ |
| Natural attapulgite | 1.8 |
| Min-U-Gel 200 | 1.0 |
| Min-U-Gel 400 | 19.9 |
| Attagel 50 | 33.1 |
| Example 1 | 42.8 |
| Example 2 | 58.7 |
| Example 3 | 46.6 |
| Example 4 | 40.9 |
| Example 5 | 78.9 |
| Example 6 | 64.1 |
| Example 7 | 31.6 |
| Example 8 | 188.4 |
| Example 9 | 87.2 |
| Example 10 | 87.9 |
| Example 11 | 249.4 |
| Example 12 | 330.3 |
| Example 13 | 395.0 |
| Example 14 | 415.1 |

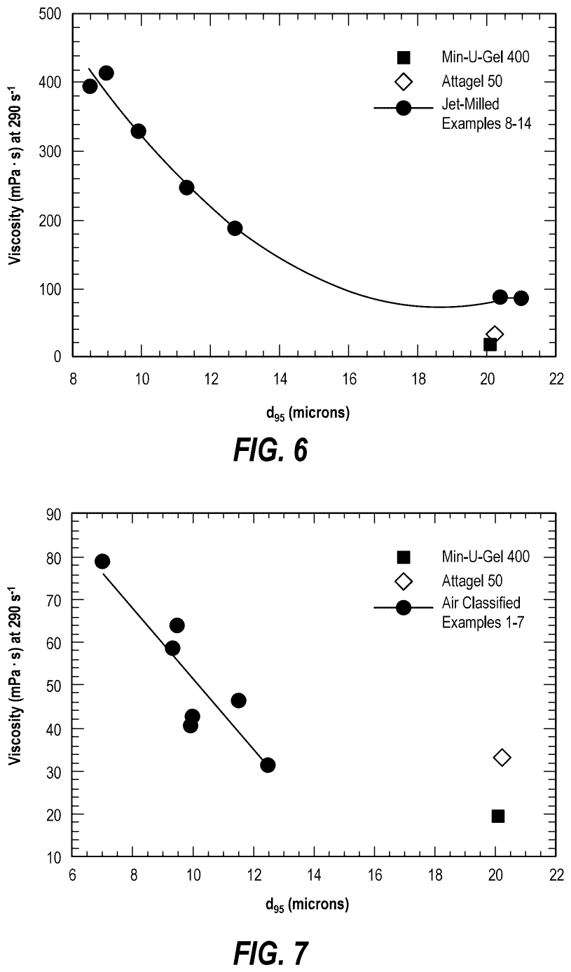

As can be seen in Table 7, the viscosities of the jet milled Examples 8-14 are significantly better than those of Examples 1-7, which were classified. FIG. 6 is a graph illustrating the relationship between the dos and viscosity in mineral spirits at a shear rate of 290 s⁻¹ for Examples 8-14, and commercially available Min-U-Gel 400 and Attagel 50 products. FIG. 7 is a graph illustrating the relationship between the d₉₅ and viscosity in mineral spirits at a shear rate of 290 s⁻¹ for Examples 1-7, and commercially available Min-U-Gel 400 and Attagel 50 products.

Both FIGS. 6 and 7 illustrate a generally decreasing viscosity trend as the dos size increases. Surprisingly, however, at comparable d₉₅, the magnitude of the viscosity in the nonpolar solvent for the air classified Examples 1-7 (see FIG. 7 and Table 7) is significantly less than the magnitude of the viscosity in the nonpolar solvent for the jet milled Examples 8-14 (see FIG. 6 and Table 7). For example, the inventors had expected that the jet milled product of Example 12, which had a dos of 9.94 microns, would have the same viscosity as the classified product of Example 1, which had substantially the same d₉₅ of 9.95 microns. To the contrary, the viscosity of the jet milled product of Example 12 was 330.3 mPa·s in mineral spirits at shear rate of 290 s⁻¹ whereas the viscosity of the classified product of Example 1 was only 42.8 mPa·s in mineral spirits at the same shear rate of 290 s⁻¹. This very large discrepancy between the viscosity characteristics of jet milled Examples and classified Examples having comparable d₉₅ occurred consistently, indicating that a similar d₉₅ between classified material and jet milled material was not indicative of similar rhelogical characteristics in nonpolar liquids such as solvents (e.g., mineral spirits). Similarly, similar d₅₀ and d₅ between classified material and jet milled material was surprisingly not found to be indicative of similar viscosity characteristics in nonpolar liquids such as solvents (e.g., mineral spirits.)

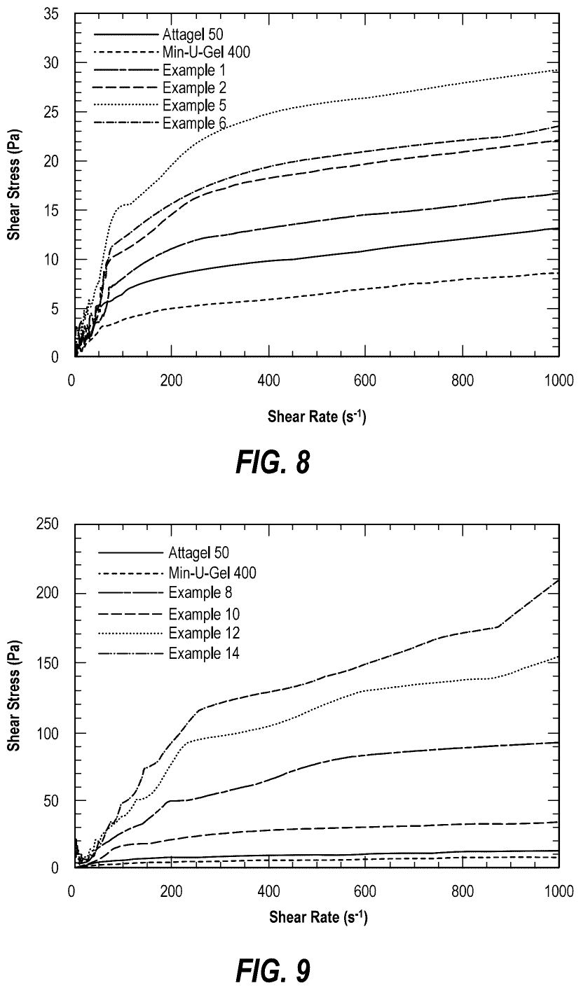

FIGS. 8-9 are rheograms illustrating the rheological characteristics of the various Examples. FIG. 8 is a rheogram illustrating the relationship between shear stress (measured in Pa) at different shear rates (s⁻¹) in mineral spirits for Examples 1-2 and 5-6, and commercially available Min-U-Gel 400 and Attagel 50 products. FIG. 9 is a rheogram illustrating the relationship between shear stress (measured in Pa) at different shear rates (s⁻¹) in mineral spirits for Examples 8, 10, 12 and 14, and commercially available Min-U-Gel 400 and Attagel 50 products. Shear stress is equivalent to the shear force (in N, newton) divided by the shear area A (in square meters). The values in FIGS. 8-9 for shear stress were obtained by a rheometer. The Rheometer R/S+ utilized was a rotational steady state controlled shear stress rheometer which can be operated in controlled shear rate mode, and may be used to determine shear stress and shear rate. Viscosity may be calculated by dividing shear stress with shear rate. The measuring sample was positioned in a measuring gap between the stationary measuring cup and the rotating measuring bob (Searle-principle), respectively between the rotating cone or plate and the stationary lower plate (cone/plate, cone/cone measuring system).

Both FIGS. 8 and 9 illustrate a generally increasing shear stress trend as the shear rate increases. Examples of the classified product (Examples 1-2 and 5-6) generally showed increasing shear stress across the various shear rates as the dos size decreased. Similarly, Examples of the jet milled product (Examples 8, 10, 12 and 14) showed increasing shear stress across the various shear rates as the d₉₅ size decreased.

Surprisingly, however, at comparable dos and shear rate, the magnitude of the shear stress across the various shear rates in the nonpolar solvent for the classified product (Examples 1-2 and 5-6) is significantly less than the magnitude of the shear stress across the various shear rates in the nonpolar solvent for the jet milled product of Examples 8, 10, 12 and 14. For example, the inventors had expected that the jet milled product of Example 12, which had a dos of 9.94 microns, would have the same shear stress characteristic as the classified product of Example 1, which had substantially the same d₉₅ of 9.95 microns. To the contrary, the shear stress of the jet milled product of Example 12 was more than 150 Pa at a shear rate of 1000 s⁻¹ and the shear stress of the classified product of Example I was slightly less than 17 Pa at the same shear rate of 1000 s⁻¹. This very large discrepancy between the shear stress characteristics of jet milled Examples and classified Examples having comparable dos and shear rate occurred consistently, indicating that a similar dos between classified material and jet milled material was not indicative of similar shear stress characteristics in nonpolar liquids such as solvents (e.g., mineral spirits).

Zeta potential is a physical property which is exhibited by a particle in suspension. Zeta potential is the charge on a particle at the shear plane. This potential is measured in milliVolts (mV). Zeta potential indicates the stability of colloidal dispersions. Colloids with high zeta potential (negative or positive) are electrically stabilized. It is the electrical potential at the slipping plane that is the interface which separates mobile fluid from fluid that remains attached to the surface. Table 8 illustrates the zeta potential of various samples, as measured in distilled water by a Malvern Zetasizer instrument. As can be seen in Table 8, the classified attapulgite particles of Examples 4 and 5 and the jet milled attapulgite particles of Examples 9 and 14 have much higher zeta potential than natural attapulgite and commercial attapulgite products.

TABLE 8
Zeta potential (mV).

| Samples | Zeta potential (mV) |
|---|---|
| Natural attapulgite | −1.77 |
| Min-U-Gel 200 | 1.27 |
| Min-U-Gel 400 | −2.2 |
| Attagel 50 | −3.24 |
| Example 4 | −6.87 |
| Example 5 | −5.2 |
| Example 9 | −6.04 |
| Example 14 | −7.75 |

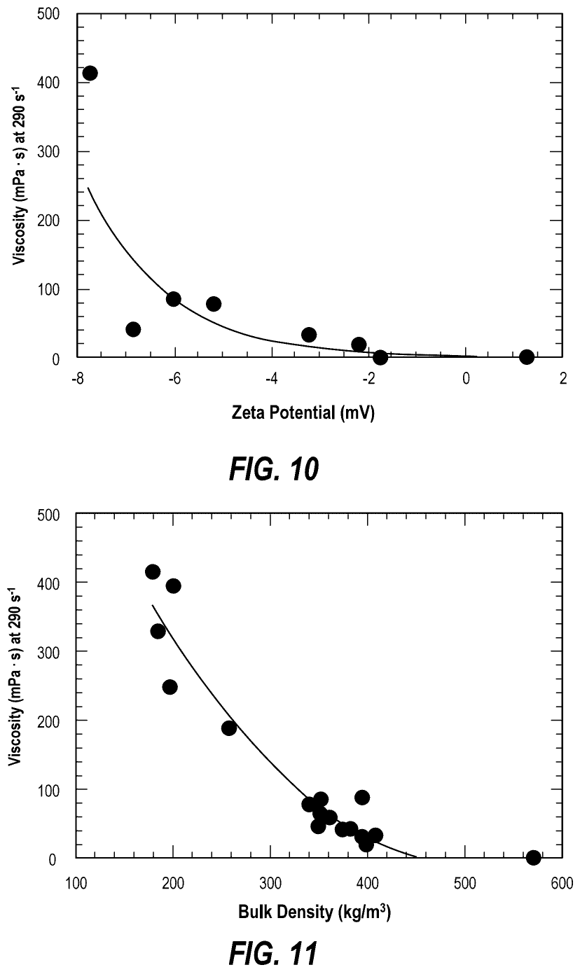

FIG. 10 graphically illustrates the relationship of the viscosity (mPa·s) at shear rate of 290 s⁻¹ in mineral spirits (see Table 7) to the zeta potential (mV) for the samples in Table 8. As can been seen in FIG. 10, Example 14, which exhibits a significantly higher viscosity, has a more negative zeta potential than natural attapulgite, or the commercially available attapulgite products Min-U-Gel and Attagel 50. As illustrated in FIG. 10, Example 14, which has a larger d₅ and d₅₀ than the air classified Examples 4-5 and a d₉₅ that is in between that of Examples 4-5, yet has a lower zeta potential and a significantly higher viscosity in mineral spirits. Jet milled example 9, which has a larger d₅ and d₅₀ and d₉₅ than the air classified Examples 4-5 and a zeta potential between that of air classified Examples 4-5, demonstrates a much higher viscosity than that of Examples 4-5 but a lower zeta potential and lower viscosity than Jet milled Example 14.

FIG. 11 is a graph illustrating the relationship between viscosity (mPa·s) at shear rate of 290 s⁻¹ in mineral spirits (see Table 7) and bulk density (kg/m³) of samples in Table 6. As can be seen Examples 8, and 11-14 have significantly lower bulk density and significantly higher viscosity than the natural feed attapulgite of Feed Material A, the commercially available Min-U-Gel 200 and Attagel 50, and the air classified Examples 1-7.

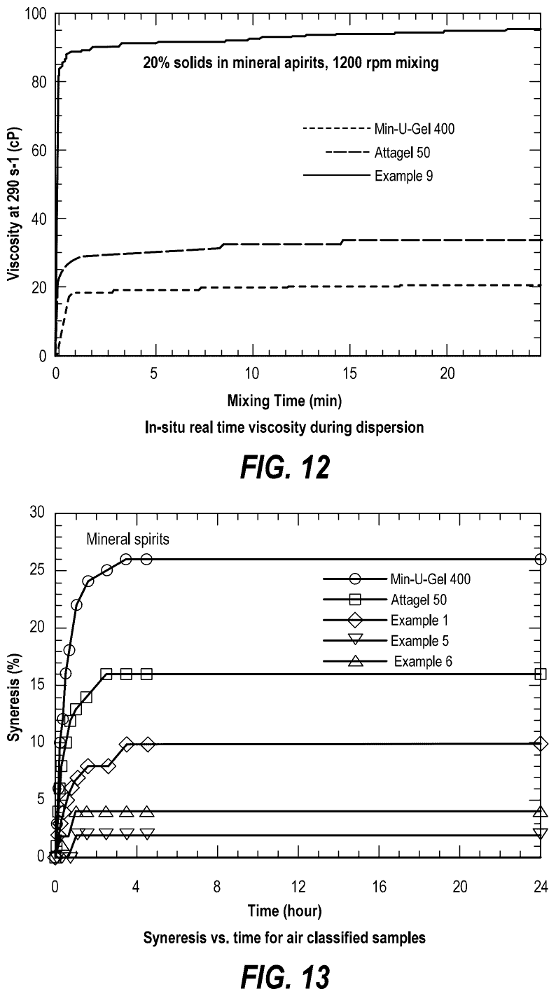

To measure in-situ real time viscosity during dispersion, an OFI Model 900 Viscometer and an IKA mixer were placed in a plastic vessel containing an attapulgite and mineral spirits slurry. 116.5 g of attapulgite was added to 466 g of mineral spirits to make the slurry with a total volume 650.15 ml and 20 wt. % solid. Mixing speed of IKA mixer was fixed at 1200 rpm during the test. Viscosity was collected every 2 seconds for 30 minutes. FIG. 12 is a graph illustrating the resulting in-situ real time viscosity at 290 s⁻¹ centipoise (cP) and dispersion mixing time of jet milled example 9, as compared to commercially available Min-U-Gel 400 and Attagel 50 products. As can be seen example 9 demonstrated significantly higher viscosity than either of the Min-U-Gel 400 and Attagel 50 products.

Syneresis (the separating out of a liquid from a slurry) over time was measured for various examples and compared to that of commercially available Min-U-Gel 400 and Attagel 50 products. To obtain the measurements, 10 g of attapulgite was mixed with 40 g of mineral spirits on a magnetic stirrer at 1000 rpm for 30 minutes (min). The mixed slurry was poured into a 50 ml graduate cylinder. Syneresis was recorded as the percentage of clear liquid volume as the total volume of the slurry. Syneresis data were collected at 3 min, 8 min, 15 min, 20 min, 30 min, 40 min, 60 min, 1.5 hours, 2.5 hours, 3.5 hours, 4.5 hours and 24 hours.

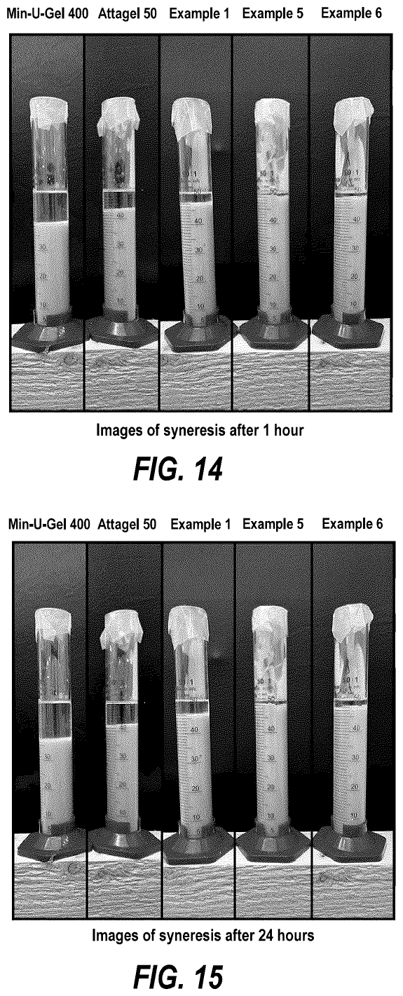

FIG. 13 is a graph illustrating the syneresis percent (%) over time (hours) in mineral spirits as measured for air classified examples 1, 5 and 6 and commercially available Min-U-Gel 400 and Attagel 50 products. As can be seen each of examples 1, 5 and 6 demonstrated significantly lower syneresis than either of the Min-U-Gel 400 and Attagel 50 products. FIG. 14 is a photo of the syneresis seen after 1 hour for the Min-U-Gel 400 and Attagel 50 products and for the air classified samples examples 1, 5 and 6. FIG. 15 is a photo of the syneresis seen after 24 hours for the Min-U-Gel 400 and Attagel 50 products and for the air classified samples examples 1, 5 and 6. The air classified products showed significantly less syneresis than the commercially available products. For example, example 1 experienced less than 10% syneresis over twenty four hours, example 5 experienced 2.5% or less syneresis over twenty four hours, and example 6 experienced 4% or less syneresis over twenty four hours. Syneresis % was calculated by dividing clean liquid volume with total volume (clear liquid+slurry).

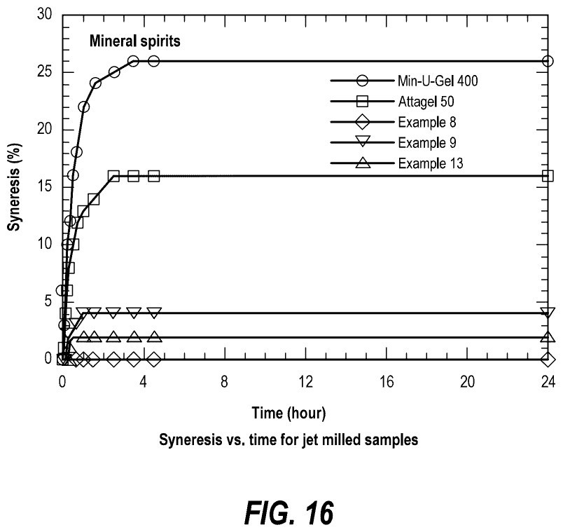

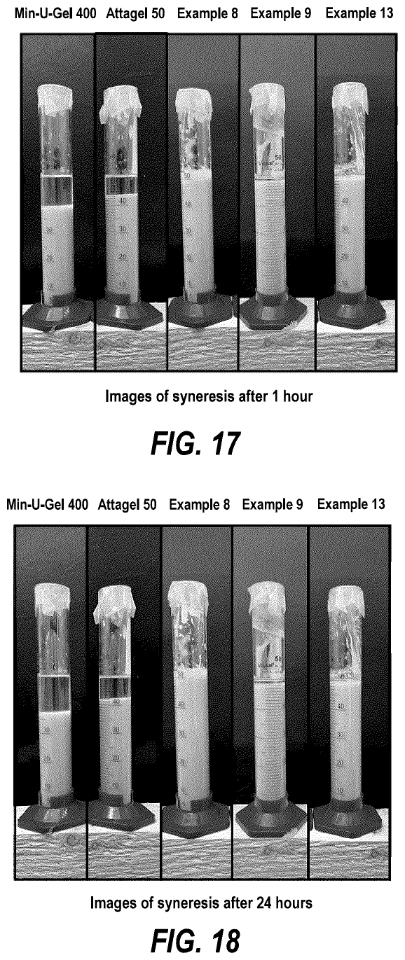

FIG. 16 is a graph illustrating the syneresis percent (%) over time (hours) in mineral spirits as measured for jet milled examples 8, 9 and 13 of the present disclosure and commercially available Min-U-Gel 400 and Attagel 50 products. FIG. 17 is a photo of the syneresis seen after 1 hour for the Min-U-Gel 400 and Attagel 50 products and for the jet milled examples 8, 9 and 13 of the present disclosure. Little to no syneresis was visible to the eye after one hour for the jet milled examples 8, 9 and 13. FIG. 18 is a photo of the syneresis seen after 24 hours for the Min-U-Gel 400 and Attagel 50 products and for the jet milled examples 8, 9 and 13 of the present disclosure. Similar to the results seen after one hour, little to no syneresis was visible to the eye after twenty-four hours for the jet milled examples 8, 9 and 13. For example, example 9 experienced 4% or less syneresis over twenty four hours, example 13 experienced 2.5% or less syneresis over twenty four hours, and example 8 experienced about 0% syneresis over twenty four hours.

### Industrial Applicability

In general, the foregoing disclosure finds utility in additives for use in improving rhelogical properties in nonpolar liquids. The novel product disclosed herein can be used as a rhelogical additive in nonpolar liquids such as those found in solvent based systems (e.g., solvent-based coatings, paints, sealants, adhesives, and alkyd paints) to improve viscosity and stability. It further acts as a thixotropic thickener and a syneresis control and suspension agent in such solvent based systems. For example, the novel product disclosed herein can be used in the solvent-based paints to improve flow and leveling, to prevent sag, to aid in suspension of pigments, to reduce syneresis, and to improve in-can stability.

From the foregoing, it will be appreciated that while only certain embodiments have been set forth for the purposes of illustration, alternatives and modifications will be apparent from the above description to those skilled in the art. These and other alternatives are considered equivalents and within the spirit and scope of this disclosure and the appended claims.

What is claimed is:

1. A product comprising:
jet milled clay, wherein the jet milled clay includes (a) jet milled attapulgite or (b) jet milled sepiolite or (c) jet milled attapulgite and jet milled sepiolite,
wherein the product or the jet milled clay has a bulk density of 140-400 kg/m³,
wherein the product or the jet milled clay has a particle size distribution having a d₉₅ of 8-13 microns,
wherein the product or the jet milled clay has a Zeta potential in a range of −3.5 to −9 mV or −3 to −7 mV as measured in distilled water,
wherein product or the jet milled clay has a surface area in the range of 110-190 m²/g as measured using the BET method.

2. The product of claim 1, wherein the product at 20 wt. % solid loading in a nonpolar liquid is adapted to increase a viscosity of the nonpolar liquid to a range of 34 (mPa·s) to 500 (mPa·s) at shear rate of 290 s⁻¹ as measured in the nonpolar liquid after dispersal of the product in the nonpolar liquid and as compared to the viscosity of the nonpolar liquid when free of the product, wherein the nonpolar liquid comprises a nonpolar solvent.

3. The product of claim 1, wherein the product at 20 wt. % solid loading in a nonpolar liquid is adapted to increase a viscosity of the nonpolar liquid to a range of 80 (mPa·s) to 450 (mPa·s) at shear rate of 290 s⁻¹ as measured in the nonpolar liquid after dispersal of the product in the nonpolar liquid and as compared to the nonpolar liquid when free of the product, wherein the nonpolar liquid comprises a nonpolar solvent.

4. The product of claim 1, wherein the product is adapted to provide zero to less than 15% syneresis or zero to less than 10% syneresis or zero to less than 5% syneresis over a twenty-four hour time period to a nonpolar liquid containing the product, wherein the nonpolar liquid comprises a nonpolar solvent.

5. The product of claim 1, wherein the product or the jet milled clay has a particle size distribution having a d₅₀ of 3-4 microns.

6. The product of claim 1, wherein the product or the jet milled clay has a particle size distribution having a d₅ of 0.2-0.5 microns.

7. The product of claim 1, wherein the weight percentage of components of the product includes 76-100 wt. % jet milled clay.

8. The product of claim 1, wherein the product or the jet milled clay has a bulk density of 160-260 kg/m³.

9. A method of producing a product for increasing a viscosity in a nonpolar liquid that comprises a nonpolar solvent, the product comprising a jet milled clay, the method comprising:
selecting a clay as feed material, wherein the clay comprises (a) attapulgite or (b) sepiolite or (c) attapulgite and sepiolite:
jet milling the clay to produce the jet milled clay,
wherein the product or the jet milled clay has a bulk density of 140-400 kg/m³, a particle size distribution having a dos of 8-13 microns, a Zeta potential of −3.5 to −9 mV as measured in distilled water, and a surface area in the range of 110-190 m²/g as measured using the BET method, and is adapted to provide zero to less than 15% syneresis over a twenty-four hour time period when mixed with the nonpolar liquid.

10. The method of claim 9, wherein a weight percentage of components of the product includes 76-100 wt. % jet milled clay, and wherein the product is adapted to provide zero to less than 10% syneresis, or zero to less than 5% syneresis over a twenty-four hour time period to the nonpolar liquid.

11. The method of claim 9, wherein product or the jet milled clay has a bulk density of 160-260 kg/m³.

12. The method of claim 9, wherein the product or the jet milled clay has a particle size distribution having a d₅₀ of 3-4 microns.

13. The method of claim 9, wherein the product or the jet milled clay has a particle size distribution having a d₅ of 0.2-0.5 microns.

14. The method of claim 9, wherein the product or the jet milled clay has a Zeta potential of −3 to −7 mV as measured in distilled water.

15. The method of claim 9, wherein the product at 20 wt. % solid loading in the nonpolar liquid is adapted to increase a viscosity of the nonpolar liquid to a range of 34 (mPa·s) to 500 (mPa·s) at shear rate of 290 s⁻¹ as measured after dispersal of the product in the nonpolar liquid and as compared to the nonpolar liquid when free of the product.

16. A nonpolar liquid comprising:
a nonpolar solvent; and
a product that includes a jet milled clay, the jet milled clay including (a) a jet milled attapulgite or (b) a jet milled sepiolite or (c) the jet milled attapulgite and the jet milled sepiolite, wherein the product or the jet milled clay has a bulk density of 140-400 kg/m³ or 160-260 kg/m³, a particle size distribution having a d₉₅ of 8-13 microns, a Zeta potential in a range of −3.5 to −9 mV in distilled water, and a surface area in the range of 110-190 m²/g as measured using the BET method,
wherein the product is loaded in the nonpolar liquid at a weight percentage to give the nonpolar liquid a viscosity of 34 (mPa·s) to 500 (mPa·s) at shear rate of 290 s⁻¹.

17. The nonpolar liquid of claim 16, wherein the product is loaded in the nonpolar liquid at a weight percentage to give the nonpolar liquid a viscosity of 80 (mPa·s) to 500 (mPa·s) at shear rate of 290 s⁻¹.

18. The nonpolar liquid of claim 16, wherein the nonpolar liquid is a solvent-based paint, a solvent-based coating or an alkyd paint.

19. The nonpolar liquid of claim 16, wherein the nonpolar liquid has 0% to 15%, or 0% to 10%, or 0% to 5% syneresis within twenty-four hours after mixing of the nonpolar solvent and the product.

20. The nonpolar liquid of claim 16, wherein the jet milled clay is 76-100 wt. % of the product.
